(19) United States
(12) Patent Application Publication
(10) Pub. No.: US 2025/0315607 A1
(43) Pub. Date: Oct. 9, 2025

(54) SYSTEM, METHOD, AND COMPUTER PROGRAM PRODUCT FOR VECTORIZING AND ANALYZING TEXT CHARACTER DATA

(71) Applicants: John Kinneman Hasley, Bolivar, PA (US); Noah Haibach, Frankfurt (DE)

(72) Inventors: John Kinneman Hasley, Bolivar, PA (US); Noah Haibach, Frankfurt (DE)

(21) Appl. No.: 19/066,555

(22) Filed: Feb. 28, 2025

Related U.S. Application Data
(60) Provisional application No. 63/555,995, filed on Apr. 8, 2024.

(51) Int. Cl. G06F 40/194; G06F 16/35; G06F 40/30

(52) U.S. Cl. CPC G06F 40/194; G06F 16/35; G06F 40/30

(57) ABSTRACT

Disclosed is a computer-implemented system and method for determining semantic differences in electronic documents using artificial intelligence. The method includes storing a first set of text data vectors in memory for a first electronic document file; receiving text character data for a second electronic document file; mapping the text character data to a tree-based data structure in memory for naïve clustering of similar documents to represent possible semantic variation within a corpus of documents; generating a second set of text data vectors for the text character data; comparing the second set of text data vectors for the text character data to the first set of text data vectors; and detecting at least one semantic difference between the first electronic document file and the second electronic document file based on the delta text data vectors.

### CROSS REFERENCE TO RELATED APPLICATIONS

This Application claims the benefit of U.S. Provisional Application No. 63/555,995 filed on Apr. 8, 2024, the disclosure of which is hereby incorporated by reference in its entirety.

### FIELD

The subject matter disclosed relates generally to vectorization of text character data, and, in some embodiments, to methods, systems, and non-transitory computer readable mediums encoded with program code for analyzing text character data contained within electronic documents by generating signal outputs via artificial intelligence. In some embodiments, methods, systems, and non-transitory computer readable media may relate to automatic analysis of text character data using artificial intelligence (e.g., machine learning models) to detect at least one semantic difference between a first electronic document file and a second electronic document file.

### BACKGROUND INFORMATION

Typically, review, management, and creation of electronic documents involves many iterations of edits, changes, and the like. Some electronic documents may be changed multiple times without any of the changes being recorded and/or tracked in any way. Sometimes, new versions of electronic documents similar to other electronic documents that came before will be reused, with slight modifications or even substantial modifications. Such slight modifications or substantial modifications may not be tracked or saved at all.

Thus, such modifications may be completely lost, causing substantial, unnecessary rework. Additionally, a large number of electronic documents need to be stored, each document having only slight variations from other documents that are stored or having slight semantic variations contained within the electronic documents, causing an increase in storage space. Thus, there is a need to consolidate changes and/or variations of multiple electronic documents stored in a database in order to reduce storage space and capture and/or track changes that have been made to reduce processing time when reviewing, creating, and managing new documents.

### SUMMARY

Embodiments may relate to a computing system for automatic analysis of text character data using artificial intelligence. The computing system may include memory configured with storage locations storing text character data. The computing system may further include a first storage device configured for storing machine learning models and text character data of a text dataset. The computing system may further include at least one display device. The computing system may further include a processor configured with program code that, when the program code is executed, may cause the processor to receive a text dataset including text character data. The program code, when executed, may cause the processor to load and execute a machine learning model stored on the first storage device. The text dataset may be provided as input to the machine learning model. The program code, when executed, may cause the processor to generate an inference for the text character data based on analyzing one or more features of the text character data. The program code, when executed, may cause the processor to map the text character data to a tree-based data structure in memory locations of the memory based on one or more dimensions of the text character data. The tree-based data structure may include a recursive network including a root node and plural child nodes associated with the root node. The tree-based data structure may contain a lower layer of child nodes associated with the root node. The text character data may be mapped to the lower layer of child nodes in the memory. The program code, when executed, may cause the processor to generate plural text data vectors for the text character data based on at least one of the plural child nodes and the root node associated with the text character data. Each of the plural text data vectors may correspond to a memory location in the memory. The program code, when executed, may cause the processor to generate at least one display output based on the plural text data vectors for the text character data. The program code, when executed, may cause the processor to display the display output on the at least one display device.

Embodiments may relate to a computer-implemented method for determining semantic differences in electronic documents using artificial intelligence. The method may include storing a first set of text data vectors in memory corresponding to a first electronic document file. The method may further include receiving a text dataset in the form of a second electronic document file. The electronic document file may include text character data. The method may further include mapping the text character data to a tree-based data structure in memory locations of the memory based on the one or more dimensions of the text character data that allows for naïve clustering of similar documents and may represent plural semantic variations within a corpus of documents. The method may further include generating a second set of text data vectors for the text character data based on the mapping of the text character data to the tree-based data structure in the memory. The method may further include comparing the second set of text data vectors for the text character data to the first set of text data vectors corresponding to the first electronic document file. Differences between the second set of text data vectors and the first set of text data vectors may be stored as delta text data vectors. The method may further include detecting at least one semantic difference between the first electronic document file and the second electronic document file based on the delta text data vectors.

Embodiments may relate to a computer program product for analyzing electronic documents. The computer program product may include a non-transitory computer-readable medium including program code that, when executed by a processor, causes the processor to receive text character data. The program code, when executed, may further cause the processor to input the text character data to a machine learning model. The program code, when executed, may further cause the processor to classify the text character data based on a classification output of the text character data generated by the machine learning model. The program code, when executed, may further cause the processor to map the text character data to a tree-based data structure in memory locations of the memory based on one or more dimensions of the text character data that allows for naïve clustering of similar documents and may represent plural semantic variations within a corpus of documents. The program code, when executed, may further cause the processor to generate plural text data vectors for the text character. The plural text data vectors may represent the mapping of the text character data to the tree-based data structure. The program code, when executed, may further cause the processor to generate a display output based on the plural text data vectors for the text character data. The program code, when executed, may further cause the processor to display the display output on the at least one display device.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for automatic analysis of text character data using artificial intelligence as disclosed herein;

FIG. 2 is a flow diagram of an exemplary method for automatic analysis of text character data using artificial intelligence as disclosed herein;

FIG. 3 is a diagram of an exemplary system environment for automatic analysis of text character data using artificial intelligence as disclosed herein;

FIG. 4 is a diagram of exemplary representation of text character data for an electronic document as disclosed herein;

FIG. 5 is a diagram of an exemplary representation of text character data of an electronic document represented as a tree-based data structure including a root node and plural child nodes as disclosed herein;

FIG. 6 is a diagram of an exemplary display generated on a display device showing various data objects that can be used to provide inputs for analyzing text character data in an electronic document; and

FIG. 7 is a diagram of exemplary components of a computing device and/or system as disclosed herein.

### DETAILED DESCRIPTION

In accordance with exemplary embodiments, computing systems may be used for automatic analysis of text character data using artificial intelligence (e.g., machine learning models) to detect at least one semantic difference between a first electronic document file and a second electronic document file storage system. According to some embodiments, machine learning models may classify text character data for various layers of a tree-node data structure such that the text character data may be stored in memory with particular relationships useful for encoding the text character data so that the text character data may be tracked, analyzed, and categorized for semantic relationships. In this way, embodiments disclosed herein may reduce storage requirements for storing large amounts of electronic documents and reduce storage requirements for storing text character data. Embodiments may also reduce storage requirements needed to store changes of electronic documents that are tracked. Additionally, embodiments may provide for efficient analysis of electronic documents such that processing time can be reduced for analyzing a large amount of documents when detecting semantic differences among a corpus of electronic documents.

Design and/or structure of software and/or hardware of various embodiments may include a mapping module and a machine learning (ML) model execution module. The mapping module and the ML model execution module may be instantiated in memory and/or executed by a processor to map text character data to data structures in memory and execute machine learning models, respectively. The mapping module and ML model execution module may contain data and/or properties of various systems such that a processor may execute machine learning models within the various systems. In this way, the mapping module and the ML model execution module provide interfaces and/or special program code for a processor to map, store, and/or vectorize text character data for analyzing electronic documents. With the mapping module, ML model execution module, and other modules, a processor may be specifically configured to load and execute various machine learning models for analyzing text character data, map text character data to data structures in memory, and generate text data vectors that facilitate automatic analysis of electronic documents to reduce storage requirements and increase processing speeds.

Embodiments disclosed herein may improve electronic document analysis and text analysis, such as natural language processing, in some instances. Embodiments may provide for increased efficiency in storage and/or retrieval of text character data stored in memory and/or storage devices. Such embodiments provide flexibility of tracking changes to electronic documents as well as analyzing electronic documents for differences in semantic meaning of text character data.

Using embodiments, a user may analyze electronic documents to efficiently determine semantic differences between documents as well as track changes to electronic documents. Users may efficiently determine differences among a large number of documents (e.g., thousands) in a short time, and such differences may be analyzed with regard to semantic meaning within the text character data based on, for example, natural language processing.

Embodiments disclosed herein may improve the operation of a processor to analyze electronic documents and map and/or store text character data using a variety of computing devices and platforms.

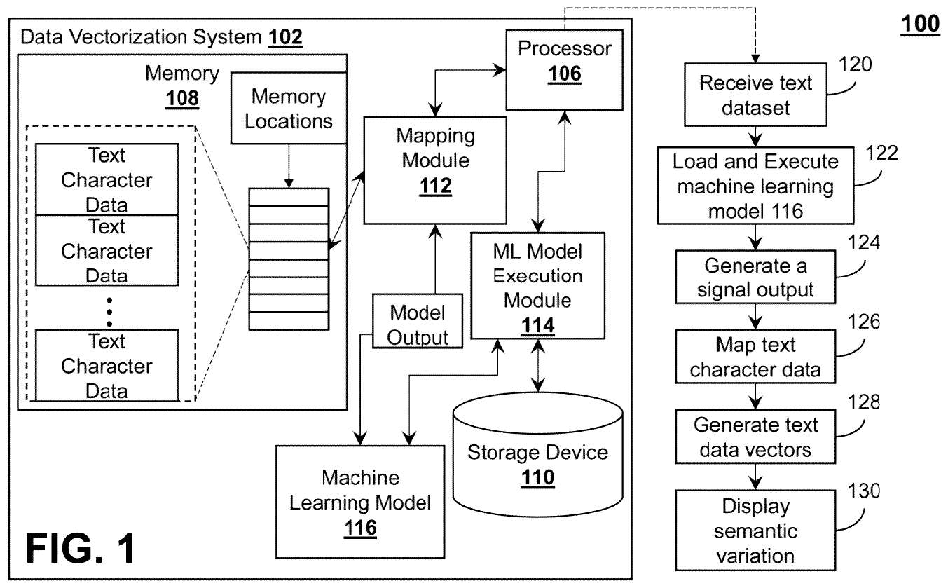

FIG. 1 shows a diagram of an exemplary system configuration for automatic analysis of text character data using artificial intelligence as disclosed herein. The various components of FIG. 1 may be implemented in and/or processed by a processor (e.g., a CPU) and/or on any number of distributed processors (e.g., a distributed and/or decentralized computing system) coupled with memory and connected via a communications network. Each of the components shown in FIG. 1 are described in the context of an exemplary embodiment.

As shown in FIG. 1, embodiments relate to a computing system 100 configured for automatic analysis of text character data using artificial intelligence. In some embodiments, computing system 100 may be configured for automatic analysis of text character data using artificial intelligence (e.g., machine learning) within a computing network. Computing system 100 may include data vectorization system 102, processor 106, memory 108, storage device 110, mapping module 112, ML model execution module 114, and machine learning model 116.

Computing system 100 may be configured for automatic analysis of text character data using machine learning model 116 within a computing network. In some embodiments, computing system 100 may include a computing node connected to data vectorization system 102 via a communication network. Computing system 100 may include memory 108 including memory storage locations configured to store data structures including text character data. Computing system 100 may include storage device 110 configured for storing electronic documents and/or text character data. Computing system 100 may include processor 106 configured with mapping module 112 and ML model execution module 114. Processor 106 may be configured to execute program code that, when executed, may cause processor 106 to execute mapping module 112 and ML model execution module 114. Execution of mapping module 112 and ML model execution module 114 may configure processor 106 to map text character data to variables and/or locations within one or more data structures that are stored in various memory locations of memory 108. ML model execution module 114 may configure processor 106 to store and/or execute one or more machine learning models 116. Mapping module 112 may configure processor 106 to store model output from machine learning model 116 in a first storage location and/or a first data structure in memory 108. Mapping module 112 may configure processor 106 to read memory 108 to extract text character data and to generate text data vectors for storage in memory 108 and/or storage device 110.

The program code may cause processor 106 to receive a text dataset including text character data. For example, processor 106 may receive a text dataset as input from a user, one or more other computing devices (e.g., computing nodes), or other input source.

The program code may cause processor 106 to load and execute a machine learning model stored on the first storage device. For example, processor 106 may load machine learning model 116 from storage device 110 and processor 106 may execute machine learning model 116. In some embodiments, the text dataset and/or the text character data may be provided as input to machine learning model 116.

The program code may cause processor 106 to generate an inference (e.g., via executing ML model execution module and/or machine learning model 116) for the text character data based on analyzing one or more features of the text character data. In some embodiments, the one or more features of the text character data may include a semantic meaning (e.g., a form of text, a type and/or meaning of text, and/or the like). In some embodiments, a type of text may include a part of speech or a type of word (e.g., noun, verb, etc.) while a meaning of text may include a domain (e.g., a domain specific meaning) such as a legal domain, or other business or leisure domain. For example, the text “confidential” may have a first meaning of text in a legal domain, a second meaning of text in another business domain (e.g., medical, financial, etc.)., and/or a third meaning of text in a plain and ordinary use of the text.

The program code may cause processor 106 to map the text character data to a tree-based data structure in memory locations of memory 108 based on one or more dimensions of the text character data. In some embodiments, the one or more dimensions of the text character data may allow for naïve clustering of similar documents and can represent many possible semantic variations within a corpus of electronic documents. In some embodiments, the tree-based data structure may include a recursive network including a root node and plural child nodes associated with the root node. In some embodiments, the tree-based data structure may contain a lower layer of child nodes associated with the root node. In some embodiments, the text character data may be mapped to the lower layer of child nodes in memory 108.

The program code may cause processor 106 to generate plural text data vectors for the text character data based on at least one of the plural child nodes and the root node associated with the text character data. In some embodiments, each of the plural text data vectors corresponds to at least one memory location in memory 108.

In some embodiments, each child node of the plural child nodes in memory 108 may be associated with a label (e.g., an identifier) based on the child node and each parent node that is associated with the child node.

The program code may cause processor 106 to generate at least one display output based on the plural text data vectors for the text character data. For example, processor 106 may generate a plot or graph view as the display output based on the plural text data vectors for the text character data. As another example, the display output may show a histogram of the plural text data vectors.

The program code may cause processor 106 to display the display output on the at least one display device. For example, processor 106 may display the display output on a display device, such as a computer monitor. Processor 106 may cause the display device to render a graph or histogram representing the text data vectors. Other examples of displays that processor 106 may cause the display device to render based on the text data vectors may include a scatter plot, a partial density distribution, a percentage ranking, another type of ranking and/or list, a radiant spectrum rendering various colors representing values and/or percentages, a bi-directional bar chart (e.g., displaying frequency), and/or other type of breakdown displaying an amount and/or variation of data collected and analyzed as text data vectors. The granularity of the tree data structure is what allows the text data vectors to be represented as different displays and/or rendered representations and/or visualizations of data stored in the tree-based data structure.

Data vectorization system 102 may include one or more computing devices including one or more processors (e.g., processor 106) configured to execute software instructions. For example, data vectorization system 102 may include a desktop computer, a portable computer (e.g., laptop computer, tablet computer), a workstation, a mobile device (e.g., smartphone, cellular phone, personal digital assistant, wearable device), a server, and/or other like devices. Data vectorization system 102 may include a computing device configured to communicate with one or more other computing devices over a network. Data vectorization system 102 may include a group of computing devices (e.g., a group of servers) and/or other like devices. In some embodiments, data vectorization system 102 may include a data storage device (e.g., storage device 110). Alternatively, a data storage device may be separate from data vectorization system 102 and may be in communication with data vectorization system 102.

Processor 106 may be implemented in hardware, software, or a combination of hardware and software. For example, processor 106 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. Processor 106 may be coupled to memory 108 via a data bus to transfer data between processor 106 and memory 108.

Memory 108 may include random access memory (RAM), read-only memory (ROM), and/or another type of dynamic or static storage device (e.g., flash memory, magnetic memory, optical memory, etc.) that stores information and/or software instructions for use by processor 106. Memory 108 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 108 from another computer-readable medium or from another device via a communication interface with data vectorization system 102. When executed, software instructions stored in memory 108 may cause processor 106 to perform one or more processes described herein. Embodiments described herein are not limited to any specific combination of hardware circuitry and software.

Storage device 110 may include random access memory (RAM), read only memory (ROM), and/or another type of dynamic or static storage device (e.g., flash memory, magnetic memory, optical memory, etc.) that stores information for use by data vectorization system 102 and/or processor 106. For example, storage device 110 may store one or more machine learning models, text character data, and/or text data vectors. Storage device 110 may store model objects including machine learning model 116, text datasets including text character data, and/or vectorized text character data such as text data vectors representing text character data stored in a tree-based data structure in memory 108. In some embodiments, storage device 110 may include a non-transitory computer readable medium that may store information, software, and/or machine learning models related to the operation and use of data vectorization system 102 and/or processor 106. For example, storage device 110 may include a hard disk (e.g., a magnetic disk, an optical disk, a magneto-optic disk, a solid-state disk, etc.) and/or another type of computer-readable medium. In some embodiments, data vectorization system 102 may transmit information to and/or receive information from processor 106.

Storage device 110 may include a computing device (e.g., a database device) configured to communicate with processor 106 via a bus or a network environment. For example, storage device 110 may include a server, a group of servers, and/or other like devices. In some embodiments, storage device 110 may be associated with one or more computing devices providing interfaces such that a user may interact with storage device 110 via the one or more computing devices. Storage device 110 may be in communication with data vectorization system 102 and/or processor 106 such that storage device 110 is separate from data vectorization system 102 and/or processor 106. Alternatively, storage device 110 may be part (e.g., a component) of data vectorization system 102 (e.g., as shown in FIG. 1).

In some embodiments, storage device 110 may include a device capable of storing data (e.g., a database). In some embodiments, storage device 110 may include a collection of data (e.g., text character data, text data vectors, and/or the like) stored and accessible by one or more computing devices and/or computing nodes. Storage device 110 may include file system storage, cloud storage, in-memory storage, and/or the like. Storage device 110 may include non-volatile storage (e.g., flash memory, magnetic media), volatile storage (e.g., random access memory (RAM)), or both non-volatile and volatile storage. In some embodiments, storage device 110 may be hosted (e.g., stored and permitted to be accessed by other computing devices via a network environment) on a computing device and/or computing node separate from data vectorization system 102.

In some embodiments, storage device 110 may be configured to communicate with processor 106 via ML model execution module 114. In some embodiments, storage device 110 may be updated with new machine learning models 116, text character data, and/or text data vectors as new text datasets and/or text character data are received and processed. For example, new text character data may be used to train or retrain machine learning model 116 to generate new machine learning models for later execution, which can be stored in storage device 110.

As used herein, a module (e.g., software module, software/hardware module, and/or the like) or a service (e.g., software service, microservice, and/or the like) may refer to a loosely-coupled software application and/or a loosely-coupled software service that is designed to facilitate software reuse. Software modules and/or services may include interfaces which are treated as a public API. The software module and/or software service may exist and may be reusable (e.g., portable to other software applications and/or systems without requiring changes to the module) independent of other software modules and/or software services.

One or more modules may be used in a single application and/or system (e.g., data vectorization system 102) to provide a desired functionality of that application and/or system. Modules, as used herein, may include hardware, software (e.g., software instructions, program code, etc.), or a combination of both hardware and software. Some modules of data vectorization system 102 may include mapping module 112 and ML model execution module 114.

Mapping module 112 may include a component for interfacing processor 106 with memory 108. For example, mapping module 112 may allow processor 106 to interface with memory 108 such that processor 106 may store and/or retrieve data, objects, and/or data structures in memory 108 (e.g., text character data, text data vectors, and/or the like).

In some embodiments, mapping module 112 may include a software module (e.g., a module invoked by processor 106 based on program code executed by processor 106) such that functionalities of mapping module 112 may be accessed via an API and such that mapping module 112 may be packaged into a single unit (e.g., a single unit of reusable program code) that may be easily deployed and/or shared. In some embodiments, mapping module 112 may include a combination of hardware and software (e.g., a processor configured to perform specific functions) such that mapping module 112 may perform functions and share data and/or commands with processor 106. Mapping module 112 may include various functions that may cause processor 106 to interface with memory 108 to manipulate data, data structures, and/or objects (e.g., text character data, text data vectors, tree-node data structures).

As an example, mapping module 112 may be configured to map text character data to a root node and/or plural child nodes within a tree-node data structure stored in memory 108. Mapping module may map text character data to the tree-node data structure such that each individual piece of text character data is associated with an identifier so that the text character data can be vectorized and retrieved by mapping module 112 as text data vectors. For example, each piece of text character data (e.g., paragraph, line, sentence, phrase, token, etc.) may be associated with a vector identifier and/or a vector label. In this way, mapping module 112 allows for efficient storage and retrieval of text character data such that a device (e.g., a computing device, a processor, etc.) may perform functions disclosed herein to analyze large amounts of text character data to detect semantic differences in the text character data.

As disclosed herein, a module may include software, hardware, or a combination of software and hardware. As an example, where mapping module 112 includes a software module, mapping module 112 may be configured as program code to cause processor 106 to perform various functions. Alternatively, where mapping module 112 includes software and hardware, mapping module 112 may be configured as program code and hardware (e.g., a specially configured processor) to perform various functions independent of and/or in conjunction with processor 106. In this way, mapping module 112 may be configured with its own hardware and/or processor for performing various functions and mapping module 112 may be integrated with data vectorization system 102 and/or processor 106.

ML model execution module 114 may include a component for interfacing processor 106 with storage device 110. For example, ML model execution module 114 may allow processor 106 to interface with storage device 110 such that processor 106 may store and/or retrieve machine learning models 116 in storage device 110. In some embodiments, ML model execution module 114 may be configured to execute one or more machine learning models for classifying text character data in text datasets. ML model execution module 114 may be configured to cause processor 106 to store text character data, text data vectors, and/or machine learning models 116 in storage device 110 for later use. ML model execution module 114 may be configured to cause processor 106 to interface with model storage device 110 to retrieve previously stored text data vectors and/or text character data. In this way, ML model execution module 114 may be configured to collect, monitor, and triage data that may be required to map text character data to data structures in memory 108 and to associate text character data and/or text data vectors with machine learning models 116.

In some embodiments, ML model execution module 114 may include a software module (e.g., a module invoked by processor 106 based on program code executed by processor 106) such that functionalities of ML model execution module 114 may be accessed via an API and such that ML model execution module 114 may be packaged into a single unit (e.g., a single unit of reusable program code) that may be easily deployed and/or shared. In some embodiments, ML model execution module 114 may include a combination of hardware and software (e.g., a processor configured to perform specific functions) such that ML model execution module 114 may perform functions and share data and/or commands with processor 106. ML model execution module 114 may include various functions that may cause processor 106 to interface with storage device 110 to collect, extract, triage, and assign text character data to/from objects (e.g., tree-node based data structures) in memory 108. ML model execution module 114 may retrieve data from storage device 110 and ML model execution module 114 may transmit the data to memory 108 via mapping module 112. In this way, ML model execution module 114 may act as a data manager while mapping module 112 may be the interface to memory 108 where the data may be mapped (e.g., to nodes in a tree-node data structure).

Machine learning model 116 may include plural data fields and/or parameters related to one or more machine learning models. For example, machine learning model 116 may include a number of files associated with a machine learning model. Machine learning model 116 may include one or more machine learning model files (e.g., as an object file, binary file, and/or the like) that make up a machine learning model. For example, machine learning model 116 may include one or more files containing layers and/or weights of a machine learning model (e.g., a deep neural network). In some embodiments, machine learning model 116 may be read into an application executing on processor 106 (or another processor of a remote computing node) as a file to be executed for generating one or more signal outputs (e.g., a prediction, inference, and/or the like) based on at least one input. In some embodiments, machine learning model 116 may be read into memory 108 (or another memory module of a remote computing node) such that machine learning model 116 (e.g., machine learning model files) may be executed for generating one or more signal outputs (e.g., a prediction, inference, and/or the like) based on at least one input. Machine learning model 116 may be stored and/or included in storage device 110.

As shown in FIG. 1, data vectorization system 102 (e.g., processor 106 thereof) may perform various functions based on processor 106 being configured to execute program code that, when executed, will cause processor 106 to execute mapping module 112 (e.g., program code for mapping module 112) and ML model execution module 114 (e.g., program code for ML model execution module 114). In some embodiments, processor 106 may execute mapping module 112 and ML model execution module 114 as program code. Alternatively, processor 106 may execute mapping module 112 and ML model execution module 114 by communicating with a first hardware module corresponding to class interface module 112 and communicating with a second hardware module corresponding to class data aggregator module 114, where class interface module 112 and class data aggregator module 114 are configured with first program code and second program code respectively.

Data vectorization system 102 (e.g., processor 106 thereof) may perform functions including step 120 of receiving a text dataset, step 122 of loading and executing machine learning model 116, step 124 of generating a signal output, step 126 of mapping text character data, step 128 of generating text data vectors, and step 130 of displaying semantic variation. In some embodiments, semantic variation may include semantic variation between two or more text datasets, between a new text dataset and a plurality of previously stored and analyzed text datasets, variation between two or more text data vectors, variation across a plurality of text data vectors, variation across a single text data vector, and/or variation between a single text data vector and a reduced set of text data vectors (e.g., an average text data vector, an expert-knowledge based text data vector, and/or the like).

As an example of semantic variation that can be displayed, data vectorization system 102 may cause a display device to display a representation of variation between text data vectors, across a text data vector, and a reduced set of text data vectors of the plural text data vectors stored in data vectorization system 102 (e.g., an average), and/or an expert knowledge-based vector (e.g., a flag). For example, data vectorization system 102 (e.g., processor 106 thereof) may execute program code that causes data vectorization system 102 to receive a text dataset including text character data.

In some embodiments, data vectorization system 102 (e.g., processor 106 thereof) may execute program code that causes data vectorization system 102 to load and execute machine learning model 116 stored on storage device 110. The text dataset may be provided as input to machine learning model 116 for execution of machine learning model 116.

In some embodiments, data vectorization system 102 (e.g., processor 106 thereof) may execute program code that causes data vectorization system 102 to generate a signal output (e.g., a prediction, an inference, and/or the like) for the text character data based on analyzing one or more features of the text character data. In some embodiments, one or more features of the text character data may include semantic meaning (e.g., form, type of word, etc.), number of characters in a text element (e.g., a word, a line, a paragraph, etc.), number of times a string of characters appears in a text element, and/or the like.

In some embodiments, data vectorization system 102 (e.g., processor 106 thereof) may execute program code that causes data vectorization system 102 to map the text character data to a tree-based data structure in memory locations of memory 108 based on one or more dimensions of the text character data that allows for naïve clustering of similar documents and can represent possible semantic variation within a corpus of documents. In some embodiments, the tree-based data structure may include a recursive network including a root node and plural child nodes associated with the root node. The tree-based data structure may contain a lower layer of child nodes associated with the root node. The text character data may be mapped to the lower layer of child nodes in memory 108. That is, the tree-based data structure may include plural layers of child nodes (e.g., a first layer, a second layer, a third layer, etc.).

In some embodiments, text character data may be mapped to nodes in each layer, where the lowest layer (e.g., the layer furthest from the root node) includes mappings of text character data that are more granular than higher layer node mappings. For example, a lowest layer of child nodes may be mapped to text character data including the text “home.”, while a higher layer node may be mapped to text character data including a sentence with the text “Let's go home.” The root node may be mapped to an electronic document that includes more text character data, but also include the sentence “Let's go home.” In this way, text character data may be mapped to different layers of a tree-based data structure in memory 108 for faster retrieval and more efficient analysis of large amounts of text character data.

In some embodiments, data vectorization system 102 (e.g., processor 106 thereof) may execute program code that causes data vectorization system 102 to generate plural text data vectors for the text character data based on at least one of the plural child nodes and the root node associated with the text character data. Each of the plural text data vectors may correspond to a memory location in memory 108. For example, a text data vector may be generated for each node to represent the text character data mapped to each node. As an example, a lower layer node with text character data mapped to the lower layer node may include a text data vector having an identifier (e.g., label) such as L3bii. The identifier for the text data vector identifies where the text character data has been mapped to a node in each layer of the tree-based data structure.

In some embodiments, data vectorization system 102 (e.g., processor 106 thereof) may execute program code that causes data vectorization system 102 to generate at least one display output based on the plural text data vectors for the text character data.

In some embodiments, data vectorization system 102 (e.g., processor 106 thereof) may cause at least one display device to display the display output.

The number and arrangement of systems, hardware, and/or modules shown in FIG. 1 is provided as an example. There may be additional systems, hardware, and/or modules, fewer systems, hardware, and/or modules, different systems, hardware, and/or modules, or differently arranged systems, hardware, and/or modules than those shown in FIG. 1. Furthermore, two or more systems, hardware, and/or modules shown in FIG. 1 may be implemented within a single system, hardware, and/or module. A single system, hardware, and/or module shown in FIG. 1 may be implemented as multiple, distributed systems, hardware, and/or modules. Additionally, or alternatively, a set of systems, a set of hardware, and/or a set of modules (e.g., one or more systems, one or more hardware devices, one or more modules) of FIG. 1 may perform one or more functions described as being performed by another set of systems, another set of hardware, or another set of modules of FIG. 1.

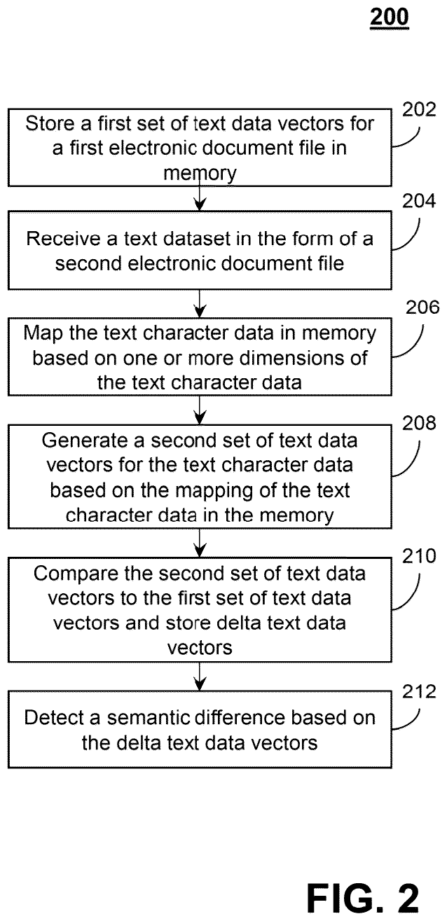

FIG. 2 shows a flow diagram of an exemplary method 200 for automatic analysis of text character data using artificial intelligence as disclosed herein. In some embodiments, one or more of the functions described with respect to method 200 may be performed (e.g., completely, partially, etc.) by data vectorization system 102 (e.g., via processor 106). In some embodiments, one or more of the steps of method 200 may be performed (e.g., completely, partially, etc.) by another system, hardware, or module or a group of systems, hardware, or modules separate from or including data vectorization system 102, such as a client device and/or a separate computing device.

In some embodiments, one or more of the steps of method 200 may be performed in a training phase. A training phase may include a computing environment where a machine learning model, such as a neural model, is being trained (e.g., training environment, model building phase, and/or the like). In some embodiments, one or more of the steps of method 200 may be performed in a testing phase. A testing phase may include a computing environment where a machine learning model, such as a neural model, is being tested and/or evaluated (e.g., testing environment, model evaluation, model validation, and/or the like). In some embodiments, one or more of the steps of method 200 may be performed in a runtime phase. A runtime phase may include a computing environment where a machine learning model, such as a neural model, is active (e.g., deployed, accessible as a service, etc.) and is capable of generating runtime signal outputs (e.g., runtime predictions) based on runtime inputs.

As shown in FIG. 2, at step 202, method 200 may include storing a first set of text data vectors for a first electronic document file in memory. For example, data vectorization system 102 (e.g., processor 106 thereof) may store a first set of text data vectors in memory corresponding to a first electronic document file. The first set of text data vectors may have been previously generated based on text character data (e.g., first text character data) that was previously mapped to memory 108 in a tree-based data structure. In this way, data vectorization system 102 may store text data vectors for a first electronic document file such that the text character data in the first electronic document file can be efficiently compared to text character data in a second electronic document file. This allows data vectorization system 102 to track changes between electronic document files, including semantic changes and/or variations, with minimal use of processing and storage resources.

At step 204, method 200 may include receiving a text dataset in the form of a second electronic document file. For example, data vectorization system 102 may receive a text dataset in the form of a second electronic document file. The second electronic document file may include second text character data. In some embodiments, the second electronic document file may include plural electronic document files and/or the second text character data may include more or less text character data than the first text character data.

In some embodiments, processor 106 may execute a trained machine learning model. Processor 106 may input the text character data to the trained machine learning model (e.g., machine learning model 116) to generate at least one signal output. For example, processor 106 may cause machine learning model 116 (e.g., via ML model execution module 114) to generate one or more classifications, including encoding the constituent and syntactic structure of documents, for the text character data based on analyzing one or more features of the text character data in the electronic document file. In some embodiments, the one or more classifications may include any one of a document classification, a section classification, a sentence classification, a phrase classification, and/or a token classification. For example, machine learning model 116 may use named entity recognition (NER) to classify text character data using a label set.

In some embodiments, a label set may be manually created such that the label set includes one or more labels representing one or more semantic permutations of an electronic document. For example, the label set may include one or more labels for text character data in an electronic document including a subject, an object, and/or a verb. Other labels may be included in the label set for different document types. For example, labels for a contract type electronic document may include clause, subclause, clause type (e.g., confidentiality, arbitration, etc.).

In some embodiments, processor 106 may execute (e.g., via ML model execution module 114) plural trained machine learning models (e.g., plural machine learning models 116). The plural trained machine learning models may be stored in storage device 110 or may be stored in a remote compute node. Processor 106 may input the text character data into the plural trained machine learning models for generating plural signal outputs (e.g., predictions, inferences, classifications, and/or the like).

In some embodiments, processor 106 may generate, with the plural trained machine learning models, plural classifications for the text character data based on analyzing one or more features of the text character data in the second electronic document file. In some embodiments, the plural classifications may include any one of a document classification, a section classification, a sentence classification, a phrase classification, and/or a token classification.

At step 206, method 200 may include mapping the text character data (e.g., the second text character data) in memory based on one or more dimensions of the text character data. For example, data vectorization system 102 (e.g., processor 106 thereof) may map the text character data to a tree-based data structure in memory locations of memory 108 based on the one or more dimensions of the text character data. In this way, data vectorization system 102 may allow for naïve clustering of similar documents to represent possible semantic variation within a corpus of documents. In some embodiments, one or more dimensions of the text character data may include a semantic meaning of the text character data, a location in the electronic document file, a form of the text character data, a length of the text character data (e.g., token length) and/or a hierarchy of the text character data (e.g., document, paragraph, line, sentence, phrase, word, token, etc.).

In some embodiments, when mapping the text character data to the tree-based data structure in memory locations of memory 108 based on the one or more dimensions of the text character data, processor 106 may map the text character data to one or more higher-level child nodes associated with the lower-level child nodes and the root node. For example, text character data may be mapped to different layers of nodes in the tree-based data structure based on an attribute and/or semantic meaning of the text character data (e.g., paragraph or line, past tense or future tense, and/or the like).

At step 208, method 200 may include generating a second set of text data vectors for the text character data (e.g., the second text character data) based on the mapping of the text character data in the memory. For example, data vectorization system 102 (e.g., processor 106 thereof) may generate a second set of text data vectors for the text character data based on the mapping of the text character data to the tree-based data structure in memory 108.

In some embodiments, text data vectors may be in a binary format for storage in memory 108. In some embodiments, where an electronic document includes text character data (e.g., a sentence, phrase, and/or the like) that cannot be vectorized, then a new “branch” may get added to the tree-based data structure, storing new data in memory 108 for the new branch.

At step 210, method 200 may include comparing the second set of text data vectors to the first set of text data vectors and storing delta text data vectors. For example, data vectorization system 102 (e.g., processor 106 thereof) may compare the second set of text data vectors for the text character data to the first set of text data vectors corresponding to the first electronic document file. Differences between the second set of text data vectors and the first set of text data vectors may be stored as delta text data vectors in memory 108. Thus, where some of the first text character data is mapped differently than some of the second text character data, those portions of first and second text character data will be mapped to different text data vectors corresponding to the tree-based data structure. When those text data vectors are compared, they will be flagged as different text data vectors, and data vectorization system 102 will then create a delta text data vector capturing the difference in text character data between the first text data vector and the second text data vector.

At step 212, method 200 may detect a semantic difference based on the delta text data vectors. For example, data vectorization system 102 (e.g., processor 106 thereof) may detect at least one semantic difference between the first electronic document file and the second electronic document file based on the delta text data vectors. Data vectorization system may detect a difference in, for example, a dimension of the first text character data and the second text character data based on delta text character data mapped to the delta text data vectors. For example, data vectorization system 102 may detect the differences as a few text characters in the text character data, and based on the text characters, may determine that a word and/or phrase was changed from a first form in the first electronic document to a second form in the second electronic document.

In some embodiments, processor 106 may determine a frequency value, rarity value, or conditional rule-based value of the plural text data vectors for the text character data in memory 108. For example, processor 106 may determine a frequency value for a portion of the plural text data vectors based on a count of a same text data vector (e.g., how many of a same text data vector are identified and stored in memory 108 from different electronic documents). In some embodiments, processor 106 may determine the rarity value for text data vectors by determining a percentage and/or ratio for a specific text data vector against the total number of text data vectors stored in memory 108. In some embodiments, a conditional rule-based value may include a comparison of text data vectors to a specific set of electronic documents and/or text data vectors previously stored and/or analyzed. Such a conditional rule may include a rule selecting a particular set of previously stored electronic documents and/or text data vectors (e.g., text data vectors analyzed and/or dated prior to a specific date, and/or the like).

In some embodiments, processor 106 may display the frequency value, rarity value, or conditional rule-based value of the plural text data vectors for the text character data as the display output on the at least one display device. For example, processor 106 may cause the at least one display device to display the frequency value, rarity value, or conditional rule-based value in the form of a graph, plot, histogram, or the like.

In some embodiments, the display output may include the text character data displayed as text characters including a coloration of text characters in the text character data corresponding to the frequency value. For example, the coloration of the text characters may be based on a frequency value range of 0% to 100%, where text characters having a frequency value closer to 0% may be displayed in red text, and text characters having a frequency value closer to 100% may be displayed in green text. Other frequency values in between 0% and 100% may be displayed based on a gradient from red to green. It should be understood that other display visuals and/or colors may be displayed to convey the frequency value of text character data stored in memory 108.

In some embodiments, processor 106 may determine a score for the text dataset based on the plural text data vectors (e.g., stored in memory 108). For example, the score may be determined using a semantic polarity of the plural text data vectors for the text character data in memory 108. That is, in some embodiments, the score may be determined based on a compositional and/or recursive analysis of one or more text data vectors. In some embodiments, processor 106 may cause the at least one display device to display the score for the text dataset as a table (e.g., in a tabular format).

In some embodiments, systems and methods may process bulk and/or batch text character data for vectorization and storage in memory 108 and/or storage device 110. For example, processor 106 may receive plural text datasets where each text dataset includes text character data. The text character data for each text dataset may or may not overlap with other text datasets that are received by processor 106. In some embodiments, processor 106 may store, in memory 108 and/or storage device 110, plural scores of the plural text datasets. Each text dataset may result in (e.g., may be used to generate) the plural text data vectors for the text character data in memory 108. In some embodiments, processor 106 may determine an average score for plural text datasets received by processor 106 based on the plural scores stored in memory 108. In some embodiments, processor 106 may cause the at least one display device to display the average score with a score for a single text dataset on the at least one display device, such that both the average score and the score for the single text dataset can be analyzed. In this way, data vectorization efficiently analyzes large numbers of text datasets and consolidates the analysis into an average for all text datasets while being able to compare to a single text dataset that was analyzed.

Steps of method 200 may be performed in various orders and sequences and are not limited to being performed in the order shown in FIG. 2. Accordingly, steps of method 200 are not limited to any particular order and may be performed by various components, whether data vectorization system 102 is implemented on a single computing device or multiple, distributed computing devices. Steps of method 200 may also be performed by a single processor of data vectorization system 102 or by multiple processors of data vectorization system 102.

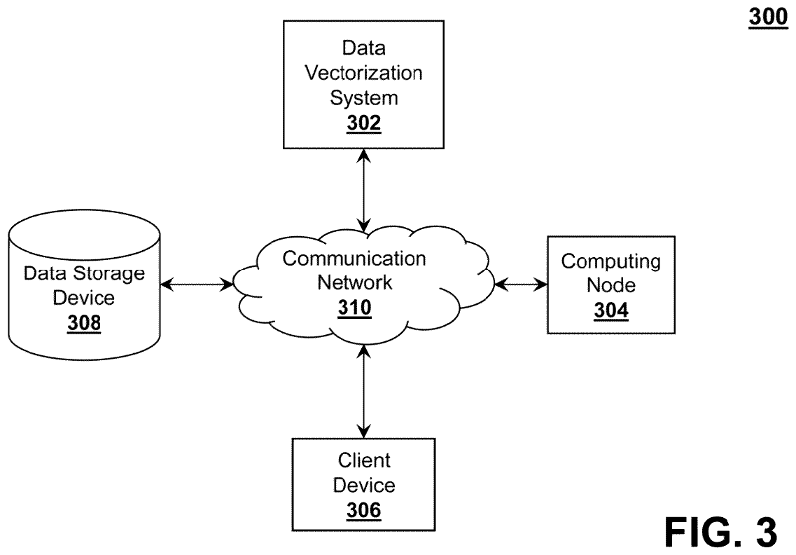

FIG. 3 shows a diagram of an exemplary system environment 300 for automatic analysis of text character data using artificial intelligence as disclosed herein. The various components of FIG. 3 may be implemented in one or more computing devices (e.g., one or more servers, client devices, user devices, and/or the like) and the one or more computing devices may be connected via a communications network (e.g., the Internet). Each of the components shown in FIG. 3 are described in the context of an exemplary embodiment.

As shown in FIG. 3, embodiments relate to a system environment 300 configured for automatic analysis of text character data using artificial intelligence in which devices, systems, methods, and/or products described herein may be implemented. System 300 may include data vectorization system 302, computing node 304, client device 306, storage device 308, and communication network 310. Data vectorization system 302, computing node 304, client device 306, data storage device 308 may interconnect (e.g., establish a connection to communicate, and/or the like) via wired connections, wireless connections, or a combination of wired and wireless connections.

Data vectorization system 302 may include one or more computing devices configured to communicate with computing node 304, client device 306, data storage device 308 via communication network 310. In some embodiments, data vectorization system 302 may include one or more computing devices such as computing node 304, client device 306, and/or data storage device 308. For example, data vectorization system 302 may include a group of computing nodes 304 and/or other like devices. In some embodiments, data vectorization system 302 may be associated with (e.g., operated by) computing node 304 and/or client device 306, as described herein. In some embodiments, data vectorization system 302 may be the same as or similar to data vectorization system 102.

Data vectorization system 302 may be implemented in a single computing device or computing node 304. Data vectorization system 302 may be implemented in one or more computing devices (e.g., a group of servers, such as a group of computing devices or computing nodes, and/or the like) as a distributed and/or decentralized system such that software instructions and/or machine learning models are implemented on different computing devices or computing nodes 304. In some embodiments, data vectorization system 302 may be associated with a local computing node, such that data vectorization system 302 is executed on the local computing node or part of data vectorization system 302 is executed on the local computing device as part of a distributed and/or decentralized computing system. Alternatively, data vectorization system 302 may include at least one local computing node executing software instructions for automatic analysis of text character data using artificial intelligence.

Computing node 304 may include one or more devices capable of receiving information and/or communicating information to data vectorization system 302, client device 306, and/or storage device 308 via communication network 310. For example, computing node 304 may include a computing device, such as a server, a group of servers, and/or other like devices. In some embodiments, computing node 304 may be associated with a server, a client device, and/or a computing device as described herein.

Client device 306 may include one or more computing devices configured to communicate with data vectorization system 302, computing node 304, and/or storage device 308 via communication network 310. For example, client device 306 may include a desktop computer (e.g., a client device that communicates with a server), a mobile device, and/or the like. In some embodiments, client device 306 may be associated with a user (e.g., an individual operating client device 306). Client device 306 may access a service (e.g., a cloud service, software-as-a-service, and/or the like) such as data vectorization system 302 to generate text data vectors based on text character data included in one or more electronic document files.

Data storage device 308 may include a database and/or storage for storing one or more text data vectors, text character data, and/or machine learning models. Data storage device 310 may be configured to communicate with data vectorization system 302, computing node 304, and/or client device 306 via communication network 310. Data storage device 308 may include a device storing data that is accessible by data vectorization system 302, computing node 304, and/or client device 306. For example, data storage device 308 may store plural text data vectors, text character data, electronic document files, machine learning models, and/or the like.

In some embodiments, data storage device 308 may be updated with new and/or updated text character data, text data vectors, and/or machine learning models received from data vectorization system 302. In this way, data vectorization system 302 may continuously store and/or update text data vectors for large numbers of electronic document files for efficient retrieval when comparing text data vectors for text character data in multiple electronic document files. In some embodiments, data storage device 308 may be the same as or similar to storage device 110. Alternatively, storage device 308 may include a standalone storage device as a separate computing device and/or a component of a computing device separate from data vectorization system 302.

Communication network 310 may include one or more wired and/or wireless networks. For example, communication network 310 may include a cellular network (e.g., a long-term evolution (LTE®) network, a third generation (3G) network, a fourth generation (4G) network, a fifth generation (5G) network, a code division multiple access (CDMA) network, and/or the like), a local area network (LAN), a wide area network (WAN), a metropolitan area network (MAN), a private network (e.g., a private network associated with data vectorization system 302), an ad hoc network, an intranet, the Internet, a fiber optic-based network, a cloud computing network, and/or the like, and/or a combination of these or other types of networks.

The number and arrangement of systems, hardware, and/or devices shown in FIG. 3 is provided as an example. There may be additional systems, hardware, and/or devices, fewer systems, hardware, and/or devices, different systems, hardware, and/or devices, or differently arranged systems, hardware, and/or devices than those shown in FIG. 3. Furthermore, two or more systems, hardware, and/or devices shown in FIG. 3 may be implemented within a single system, hardware, and/or device. A single system, hardware, and/or device shown in FIG. 3 may be implemented as multiple, distributed systems, hardware, and/or devices. Additionally, or alternatively, a set of systems, a set of hardware, and/or a set of devices of FIG. 3 may perform one or more functions described as being performed by another set of systems, another set of hardware, or another set of devices of FIG. 3.

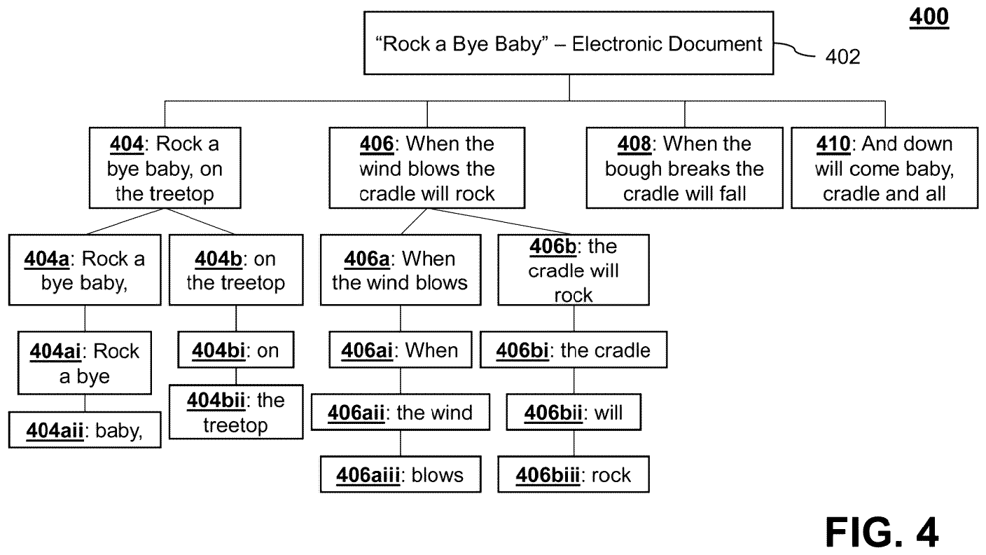

FIG. 4 shows a diagram of exemplary representation of text character data for an electronic document as disclosed herein. Each of the components and/or data objects shown in FIG. 4 may be represented in computer memory (e.g., memory 108) and may be stored in computing storage (e.g., storage device 110, data storage device 308) as text character data and/or as part of and/or related to text data vectors. In some embodiments, the components and/or data objects shown in FIG. 4 may be included in one or more electronic document files and/or data structures (e.g., tree-based data structures). FIG. 4 is provided as an example.

As shown in FIG. 4, embodiments relate to exemplary representations of text character data. In some embodiments, text character data may be configured for storage in an electronic document for use, transport, and/or processing within a computing network. In some embodiments, text character data may be stored individually in memory 108, storage device 110, and/or data storage device 308. Text character data may be stored and/or represented in various formats within a computing system (e.g., within data vectorization system 102/302), including binary, plain text, comma separated value, JavaScript Object Notation (JSON), and/or other data formats configured for storage in memory 108 and/or configured as input for a machine learning model (e.g., machine learning model 116).

FIG. 4. shows exemplary electronic document file contents 400 (e.g., text character data). Electronic document file contents 400 may include text character data representing various collections of text characters. In some embodiments, the text character data may have a semantic meaning associated with the text character data (e.g., a contract, a song, a novel, etc.). Electronic document file contents 400 may include text character data including electronic document (e.g., electronic document name) 402. Electronic document file contents 400 may include text character data including text character data representing lines 404, 406, 408, and 410 of electronic document 402. Electronic document file contents 400 may include text character data representing phrases 404a, 404b, 406a, and 406b. It should be appreciated that phrases 404a, 404b, 406a, and 406b may overlap with lines 404 and 406 and contain and/or map to a portion of text character data that is contained in and/or mapped to lines 404 and 406.

Electronic document file contents 400 may include text character data representing various tokens, where a token (e.g., token representation) may include a subset of text character data that is included in a phrase representation. For example, electronic document file contents 400 may include text character data 404ai, 404aii, 404bi, 404bii, 406ai, 406aii, 406aiii, 406bi, 406bii, and 406biii. In some embodiments, lines 408 and 410 may also be broken down into phrase and token representations.

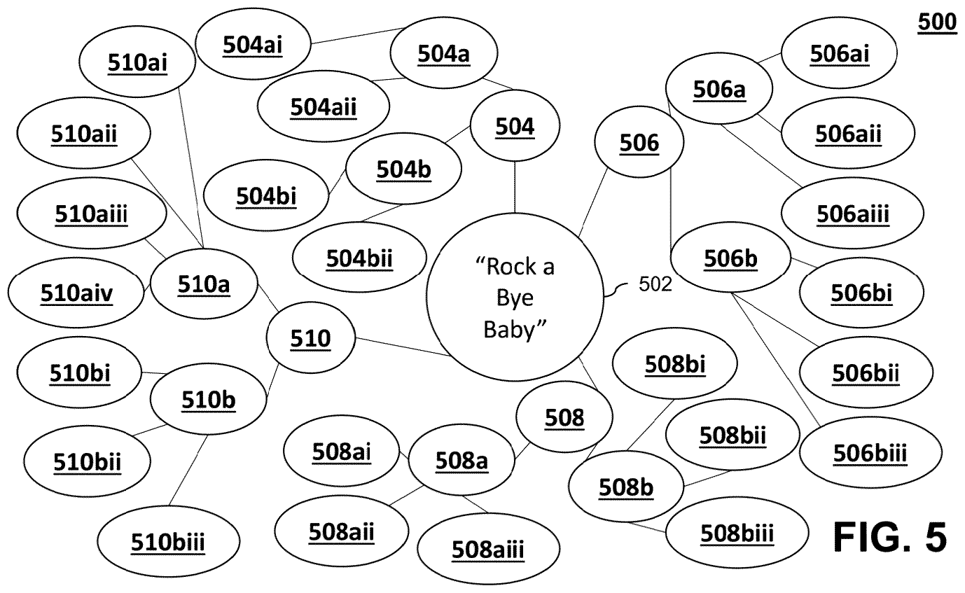

FIG. 5 shows a diagram of an exemplary representation of text character data of an electronic document represented as a tree-based data structure 500 including a root node and plural child nodes as disclosed herein. For example, tree-based data structure 500 may be implemented in data vectorization system 102 and/or data vectorization system 302.

As shown in FIG. 5, embodiments relate to a tree-based data structure 500 for storing text character data in memory to facilitate analysis of text character data using artificial intelligence. In some embodiments, tree-based data structure 500 may include text character data similar to the text character data stored in electronic document 400 as disclosed herein. FIG. 5 is shown as an example of a tree-based data structure using the text character data from electronic document 400 shown in FIG. 4. It should be understood that tree-based data structure 500 can include any text character data included in various electronic documents and is not limited to the text character data shown in the disclosed embodiments and examples. Thus, tree-based data structure 500 may include text character data relating to various document types and semantic meanings (e.g., contracts, songs, etc.).

Tree-based data structure 500 may include text character data that is vectorized (e.g., represented as a vector in memory) such that raw text character data is converted to a vector format, embedding, and/or mathematical representation. Such vector representation of text character data may allow for data vectorization system 102 to more efficiently store and analyze text character data to analyze the text character data (e.g., via analysis of the text data vectors) to detect semantic variations in the text character data.

Tree-based data structure 500 may include root node 502, a first layer of child nodes 504, 506, 508, 510, a second layer of child nodes 504a, 504b, 506a, 506b, 508a, 508b, and a third layer (e.g., a lowest layer) of child nodes 504ai, 504aii, 504bi, 504bii, 506ai-506aiii, 506bi-506biii, 508ai-508aiii, 508bi-508biii. Each child node in each layer may be stored and/or represented in memory 108 and/or storage device 110/308.

As shown in FIG. 5, the first layer of child nodes 504, 506, 508, 510 are associated with root node 502. The second layer of child nodes 504a, 504b, 506a, 506b, 508a, 508b are associated with the first layer of child nodes 504, 506, 508, 510. The third layer (e.g., a lowest layer) of child nodes 504ai, 504aii, 504bi, 504bii, 506ai-506aiii, 506bi-506biii,508ai-508aiii, 508bi-508biii is associated with the second layer of child nodes. The hierarchical association shown in FIG. 5 may be represented in memory 108 to create the tree-based data structure. For example, in some embodiments, the tree-based data structure may be stored in memory using a data value for a node and one or more pointers to one or more child nodes associated with the node. In this way, the tree-based data structure and vectorization and/or embedding of the text character data allow data vectorization system 102 to efficiently extract, store, and compare text data vectors to detect semantic variation between text data vectors and electronic documents.

The number and arrangement of nodes, text character data, and/or text data vectors shown in FIG. 5 is provided as an example. There may be additional nodes, text character data, and/or text data vectors, fewer nodes, text character data, and/or text data vectors, different nodes, text character data, and/or text data vectors, or differently arranged nodes, text character data, and/or text data vectors than those shown in FIG. 5. It should be understood that a size of a tree-based data structure and a number of nodes is only limited by hardware capabilities (e.g., memory and/or storage capacity, processing power, etc.) and is not limited purely based on embodiments disclosed herein. For example, data vectorization system 102 may store a large number of text data vectors in memory 108 having a large number of nodes, such that analysis of the text data vectors for detecting semantic variation could not practically be performed manually. Such vectorization allows for data vectorization system 102 to perform automatic analysis of text character data using artificial intelligence.

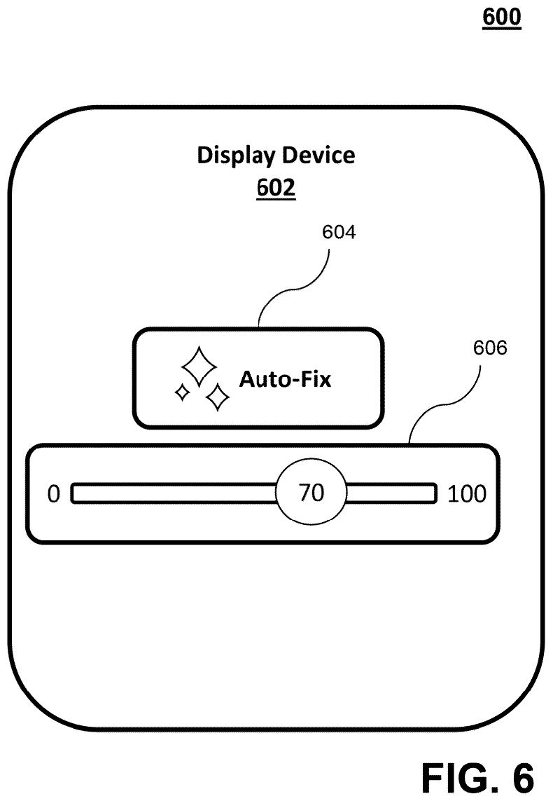

In some embodiments, processor 106 may be programmed or configured to manipulate contents of an input electronic document (e.g., a previously stored and/or analyzed electronic document) that has been previously analyzed and/or stored as text data vectors. For example, processor 106 may set a value of correspondence between 0 and 100 based on user input to one or more display objects 602, 604. As an example, at least one display device 602 may render a display object such as “Auto-Fix” button 604 and associated 0 to 100 scale 606 depicted as display objects in FIG. 6 for receiving input from a user and/or user device. In some embodiments, input provided by a user device via pressing “Auto-Fix” button 604 may cause processor 106 to generate a red-line of an original electronic document that had been previously analyzed and/or stored as one or more text data vectors, and a revised version of the original electronic document of which processor 106 has generated (e.g., via correcting and/or modifying an original electronic document) based on the input from a user device. In this way, processor 106 may automatically apply corrections, revisions, and/or changes (e.g., tracked changes, red-lines, and/or the like) to an input electronic document based on stored text data vectors that have been determined to be equal to a frequency value in previously analyzed electronic documents, where the frequency value is equal to a number input set by a user device using the 0 to 100 scale 606 depicted in FIG. 6.

In some embodiments, revisions may be generated via at least one machine learning model based on the at least one machine learning model understanding and/or learning the tree-based node structure used to store data structures for the text data vectors of an electronic document under consideration as against a vectorspace of the input electronic document. The number input at which a user device provides an input to set using 0 to 100 scale 606 may represent a threshold for the at least one machine learning model upon which the at least one machine learning model may make revisions to the input electronic document. For example, if the number input is set to 70 for 0 to 100 scale 606, as shown in FIG. 6, this number input may be used to inform the at least one machine learning model of at least two things: (1) every node in the input electronic document under consideration that matches nodes appearing in less than 70% of the vectorspace (e.g., via comparing the text data vectors stored for previously analyzed electronic documents against the text data vectors for the input electronic document) should be deleted; and (2) after the deletion of the nodes in the input electronic document, every node that matches nodes appearing in more than 70% of the vectorspace should be added into the input electronic document. An example using an input electronic document representing a contract for employment, including a non-solicitation provision, will be considered herein.

The following example demonstrates how the number input may affect processor 16 making automatic revisions to an input electronic document. Consider the non-solicitation provision presented herein:

You agree that during the period of sixty (60) months commencing on the date hereof, you shall not solicit for employment or hire any officer or senior management-level employee or plant manager of the Company with whom you first come into contact in connection with the Purpose or any other purpose. Notwithstanding the foregoing, nothing shall restrict you from (i) (a) making any general solicitation for employees or public advertising of employment opportunities (including through the use of employment agencies that may reach such employees of the Company) so long as such solicitations or advertisements are not specifically directed at any such employees of the Company and (b) the hiring of such Company employees who respond to such general solicitations for employees, (ii) hiring any employees you were in discussions with regarding possible employment prior to the signing of this agreement, (iii) hiring any employee who has been terminated by the Company prior to the commencement of employment discussions between you and such employee or (iv) soliciting or employing any such person who contacts you on their own initiative and without any direct solicitation by you.

For this example, the following assumptions may be used:

Text that is underlined occurs in less than 70% of the stored vectorspace (e.g., electronic document text data vectors stored from previously analyzed electronic documents). Text highlighted in bold occurs in greater than 70% of the stored vectorspace (e.g., the text data vectors stored for previously analyzed electronic documents), but does not occur in the input electronic document under consideration.

Upon receiving input from a user device for the “Auto-Fix” button at a 70% level for this non-solicit provision, processor 106 may execute the at least one machine learning model, where the at least one machine learning model output may include deleting (1) “sixty (60) months” (2) “or plant manager” and (3) “or any other purpose” based on analysis and/or input to the at least one machine learning model including the previously stored text data vectors and the text data vectors based on the input electronic document. The at least one machine learning model may then add in “Notwithstanding the foregoing, nothing shall restrict you from (i) (a) making any general solicitation for employees or public advertising of employment opportunities (including through the use of employment agencies that may reach such employees of the Company) so long as such solicitations or advertisements are not specifically directed at any such employees of the Company and (b) the hiring of such Company employees who respond to such general solicitations for employees, (ii) hiring any employees you were in discussions with regarding possible employment prior to the signing of this agreement, (iii) hiring any employee who has been terminated by the Company prior to the commencement of employment discussions between you and such employee or (iv) soliciting or employing any such person who contacts you on their own initiative and without any direct solicitation by you.”

In some embodiments, the at least one machine learning model may be to analyze the resulting revised electronic document, upon completing the steps of revising the input electronic document, such that the at least one machine learning model may generate and/or store data relating to the resulting revised electronic document including an indication that a revised non-solicit provision may be defective, as it would lack a duration because the at least one machine learning model automatically deleted “sixty (60) months”. If there was a duration that appeared in greater than 70% of the stored text data vectors' vectorspace, the at least one machine learning model would automatically use that duration and would add that duration into the electronic document as a revision. Alternatively, if there was no duration option in greater than 70% of the stored text data vectors' vectorspace, the at least one machine learning model may default to adding in an option that appeared with the highest frequency with the stored text data vectors (e.g., an option which may appear in less than 70% of the stored text data vectors, but that appears more than any other options).

In some embodiments, features and display objects shown in FIG. 6 may be implemented at any level of the tree-based data structure, such that user input may be provided to address e.g. a specific section, sentence, word, etc. of an electronic document without affecting any other part of the electronic document.

In some embodiments, for numeric type nodes within the tree-based data structure, using a purely identity-based comparison with the text data vectors may not be effective. Consider, for example, a monetary value node (e.g., a value of $1,000 stored in the monetary value node). It may be unlikely that two separate and/or different electronic documents would have the same dollar value included in each of the two separate electronic documents where a payment amount is stored and/or listed. In this case, an input number of 70% may not be useful and/or viable. Thus, the at least one machine learning model may use an input criteria of “greater than (or less than) a dollar value appearing in 70% of the text data vectors”, depending on whether the monetary value's magnitude is measured and/or determined to be favorable or unfavorable to a user and/or electronic document.

In some embodiments, processor 106 and/or at least one machine learning model may be programmed or configured to automatically align incoming electronic documents generated by and/or provided as input by a second computing device (e.g., a computing device in communication with and/or remote from a first computing device including processor 106 and/or executing the at least one machine learning model) storing existing electronic documents (e.g., executed electronic legal documents, and/or the like).

In some embodiments, a basis of one or more electronic documents used to calculate and/or determine a frequency of at least one piece of text data (e.g., a sentence, phrase, word, and/or the like) may be configurable, for example, based on user input provided to processor 106 and/or at least one machine learning model. Initially, all previously stored text data vectors may be used for analyzing an input electronic document. However, some electronic documents may also be grouped into clusters, either based on explicit properties (e.g., an industry of the electronic document, an amount of currency associated with the electronic document, a category of parties to the electronic document, etc.) or other features determined by unsupervised learning of the at least one machine learning model using the input electronic document and/or previously stored text data vectors as input training data. In this way, a basis for an input electronic document may be dynamic so as to be more relevant for electronic documents sharing a same type.

In some embodiments, the at least one machine learning model may make automatic edits to an input electronic document that may extend beyond a frequency analysis. For example, the at least one machine learning model may be configurable via user input to processor 106 to cause the at least one machine learning model to perform a frequency analysis (including a configurable threshold), as well as expert-derived rulesets (e.g., combinations of one or more node values which may be unfavorable for a certain document type, as well as the recommended replacement node values), customer-specified rulesets (e.g., arbitrary patterns in terms of nodes and their values, as well as replacement values).

Thus, embodiments described herein may allow for analysis and automatic revision of input electronic documents such that the input electronic documents may be analyzed and/or revised by a machine learning model based on a large number (e.g., thousands, millions) of previously stored text data vectors efficiently stored representing a large number of previously analyzed electronic documents of which the previously analyzed electronic documents had their contents analyzed and stored into a tree-based data structure for vectorization. The previously stored text data vectors may be used as a specific base line for automatically analyzing and revising at least one input electronic data file. Such embodiments may increase processing time of electronic document analysis and/or revision, while providing an efficient storage mechanism for tracking and storing all historical changes (e.g., as text data vectors) to any electronic document in a large collection of electronic documents. In this way, data vectorization system 102 may provide for reduced processing time of electronic document revisions as well as reduced resources required for storing text data included in various electronic documents, such that the text data can be easily retrieved and used for comparison against text data within an input electronic document.

Any of the processors (e.g., processor 106) disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based CPU, a DSP, a GPU, a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory; the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory (e.g., memory 108) can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing devices to implement the present methods as discussed herein. In particular, the computer programs stored on a non-transitory computer-readable medium, when executed, can enable hardware processor devices to implement the methods as discussed herein. Accordingly, such computer programs can represent controllers of the computing device.

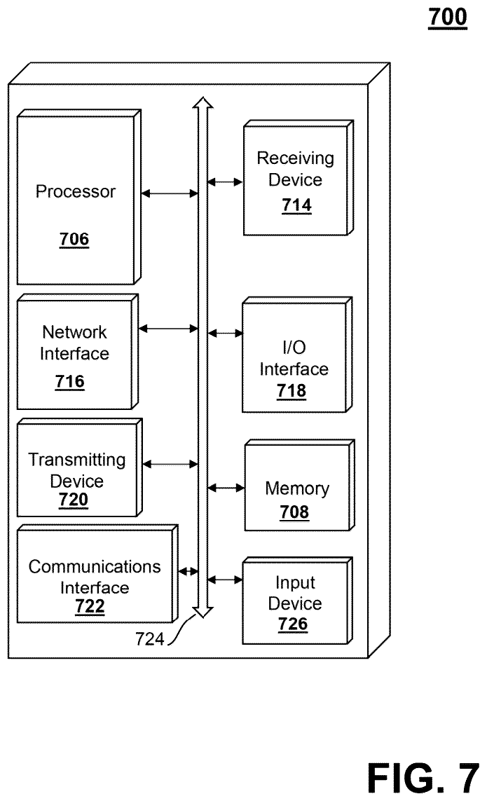

FIG. 7 shows a diagram of example components of a computing device or system 700 as disclosed herein. Computing device 700 (and/or at least one component of computing device 700) may correspond to at least one of data vectorization system 102, processor 106, memory 108, and/or storage device 110 in FIG. 1 and/or at least one of data vectorization system 302, computing node 304, client device 306, storage device 308, and/or communication network 310 in FIG. 3. In some embodiments, such systems or devices in FIGS. 1-6 may include at least one computing device 700 and/or at least one component of computing device 700. The number and arrangement of components shown in FIG. 7 are provided as an example. In some embodiments, computing device 700 may include additional components, fewer components, different components, or differently arranged components than those shown in FIG. 7. Additionally, or alternatively, a set of components (e.g., one or more components) of computing device 700 may perform one or more functions described as being performed by another set of components of computing device 700.

Computing system or device 700 may include processor 706, memory 708, receiving device 714, network interface 716, input/output (I/O) interface 718, transmitting device 720, communications interface 722, communication infrastructure 724, and input device 726. Memory 708 may be the same as or similar to memory 108 as disclosed herein. Processor 706 may be the same as or similar to processor 106 as disclosed herein. Communications infrastructure 724 may be the same as or similar to communication network 310.

Memory 708 can be configured for storing program code for at least one machine learning model. Memory 708 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 700 via a mobile communication network. According to an exemplary embodiment, an external memory device can be used in place of any resident memory devices. Data stored in system 700 may be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or CDRs generated and/or accessed by processor 706, and software or program code used by processor 706 for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

Receiving device 714 may be a combination of hardware and software components configured to receive data samples from the mobile network or database. According to exemplary embodiments, receiving device 714 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 714 can be an input device for receiving signals and/or data samples formatted according to 3GPP protocols and/or standards. Receiving device 714 can be connected to other devices via a wired or wireless network or via a wired or wireless direct link or peer-to-peer connection without an intermediate device or access point. The hardware and software components of receiving device 714 can be configured to receive the data from the mobile network according to one or more communication protocols and data formats. For example, receiving device 714 can be configured to communicate over a network, which may include a LAN, a WAN, a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, receiving device 714 can be configured to identify parts of the received data via a header and parse the data signal and/or data packet into small frames (e.g., bytes, words) or segments for further processing at processor 706.

Processor 706 can be configured for executing the program code stored in memory 708. Upon execution, the program code causes processor 706 to perform the functions at a computing node on the communication network or a remote computing device (e.g., server, computer, etc.) of the user and execute a machine learning models and/or program code for automatic analysis of text character data using artificial intelligence according to the exemplary embodiments described herein. Processor 706 can be a special purpose or a general purpose computing device encoded with program code or software for performing the exemplary functions and/or features disclosed herein. According to exemplary embodiments of the present disclosure, processor 706 can include a CPU. The CPU can be connected to the communications infrastructure including a bus, message queue, or network, multi-core message-passing scheme, for communicating with other components of computing system 700, such as memory 708, input device 726, communications interface 722, and I/O interface 718. The CPU can include one or more processors such as a microprocessor, microcomputer, programmable logic unit or any other suitable hardware computing devices as desired.

I/O interface 718 can be configured to receive the signal from processor 706 and generate an output suitable for a peripheral device via a direct wired or wireless link. I/O interface 718 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 720 can be configured to receive data from processor 706 and assemble the data into a data signal and/or data packets according to the specified communication protocol and data format of a peripheral device or remote device to which the data is to be sent. Transmitting device 720 can include any one or more of hardware and software components for generating and communicating the data signal over communications infrastructure 724 and/or via a direct wired or wireless link to a peripheral or remote device. Transmitting device 720 can be configured to transmit information according to one or more communication protocols and data formats as discussed in connection with receiving device 714.

According to exemplary embodiments described herein, memory 708 and processor 706 can store and/or execute computer program code for performing the specialized functions described herein. It should be understood that the program code can be stored on a non-transitory computer usable medium, such as memory devices for the system 700 (e.g., computing device), which may be memory semiconductors (e.g., DRAMs, etc.) or other tangible non-transitory means for providing software to system 700. The computer programs (e.g., computer control logic) or software may be stored in memory devices (e.g., device memory 708) resident on/in system 700. The computer programs may also be received from external storage devices and/or network storage locations via a communications interface. Such computer programs, when executed, may enable system 700 to implement the present methods and exemplary embodiments discussed herein. Accordingly, such computer programs may represent controllers of system 700. Where the present disclosure is implemented using software, the software may be stored in a computer program product or non-transitory computer readable medium and loaded into system 700 using any one or combination of a removable storage drive, an interface for internal or external communication, and a hard disk drive, where applicable.

### EXAMPLES

In some embodiments, machine learning model 116 may include a natural language processor that captures electronic documents in a tree-based data structure and causes a display device to display representations of data for the electronic documents based on that capture. A use case described herein may allow users to generate metadata for electronic documents and compare a single electronic document with a pre-established universe of stored electronic documents (e.g., thousands to millions of previously stored and/or analyzed electronic documents), such that data vectorization system 102 may make a precise determination of differences and/or similarity between the single electronic document and the pre-established universe of stored electronic documents.

### Text Dataset Deposit Flow Through Data Architecture

A flow of inputting electronic documents (e.g., text datasets from electronic documents) may include a method of capturing unstructured data (in the form of text character data within an electronic document) in a tree-based data structure for analysis, such that the unstructured data may be processed more efficiently with minimal use of computing resources. The tree-based data structure may include one or more root nodes which in turn may each include one or more child nodes, in a recursive fashion. Each node (e.g., root node, child node) may encode text character data and control flow data which may cause processor 106 to embed child nodes. For example, a node may be a simple Boolean node which may include or exclude a static string. Alternatively, a node may include a list which may include one or more categorical options, each of which may have a dependence on other child nodes. In some embodiments, static strings may include at least one child node nested within the static string.

As an example, an electronic document may be a contract type electronic document including the following text: “Party A shall not knowingly disclose information X for 5 years from the date of closing of transaction Y.” This electronic document may be referred to as “Doc1” herein for the foregoing example.

Doc1 may be mapped to a tree-based data structure in memory locations of memory 108 based on one or more dimensions of the text character data. For example, processor 106 may map portions of Doc1 in plural phases, where each phase breaks Doc1 down into smaller and smaller segments (e.g., paragraphs, sentences, phrases, tokens, etc.). Each of the segments may correspond to inclusion of a node and/or configuration of a node (e.g., selection of various options of a node) in the tree-based data structure. A length of text characters of each segment may be as little as one character, and may be ultimately determined by a minimum meaning-bearing character length in the document. In other words, a minimum meaning-bearing character length may be the smallest difference in text character data of an electronic document that may change the electronic document's meaning. For example, a segment in a contract could include a single comma (e.g., a length of one text character being the minimum meaning-bearing character length), as interpretation of a legal document may vary based on the presence or absence of a single comma in a contract. Alternatively, variations of segments with the same semantic meaning can be mapped to a single node. That is, the mapping from segments of text character data to node value may be many to one. Variations with identical semantic meaning may also be defined on each individual node.

Processor 106 may determine a document type of Doc1 and store all text character data for Doc1 into a first node within a first layer of child nodes at the document layer. For purposes of the example disclosed herein, it is appreciated that Doc1 may include a short excerpt of a legal contract. Since Doc1 is only a single sentence in the example disclosed herein, the text character data that gets input into the first layer of child nodes, a second layer of child nodes, and a third layer of child nodes may be the same. However, it should be appreciated that text character data input into each node of the tree-based data structure may be different and the tree-based data structure may include large amounts of text character data.

Text character data of Doc1 in the first node may be broken down, for example, by section, and may be allocated to a second node within a second layer of child nodes. An example section of a legal contract, such as a non-disclosure agreement (“NDA”), for Doc1 may include a section for non-disclosure duties of a recipient of confidential information.

Text character data of Doc1 in the second node may be further broken down by sentence, and may then be allocated to a third node within a third layer of child nodes. Such breaking down of text character data may be performed by processor 106 for phrases in Doc1 for storage in a third node in a subsequent layer of child nodes (e.g., a third layer of child nodes in the tree-based data structure).

Party A shall not knowingly disclose information X for 5 years from the date of closing of transaction Y.

Text character data of Doc1 in the first node, the second node, and the third node may be further broken down by processor 106 to generate tokens. As discussed, this step may be repeated until a minimum meaning-bearing token has been isolated in a node. As an example, the tokens for a first phrase in Doc1 may include Token i: Party A, Token ii: shall not, and tokens for a second phrase may include Token i: knowingly, Token ii: disclose, Token iii: information X. Tokens may be generated by processor 106 for each phrase (e.g., each set of text character data stored in a node at a layer of child nodes).

### Text Classification

In some embodiments, different machine learning models (e.g., machine learning models 116) that target different hierarchy levels described may be trained to classify different portions of text character data in an electronic document. It should be appreciated that each of the hierarchical levels of classification in the foregoing example (e.g., document, section, sentence, phrase, token) may be a span of characters of varying length and are provided only for example. However, there are qualitative differences that emerge based on a domain of an electronic document, as well as particulars of a machine learning model used for classification in each case (e.g., type of electronic document).

In some embodiment, a top-level classification of an electronic document type may be trained with an individual machine learning model that may use a transformer-based architecture deep learning model for context-aware classification of large sets of text character data. Such a model may function by using a large token window and/or aggregating predictions over smaller portions of a text dataset for an electronic document. Such a model may use base layers which may be trained on a baseline set of electronic documents and may be further trained (e.g., retrained, tuned, etc.) using other, more specific electronic documents. Training of a machine learning model may be continuously improved with user input data and may implement feedback from users, in some instances (e.g., supervised learning). In some embodiments, other techniques may be used for training machine learning models, including boosting techniques.

In some embodiments, an electronic document may be broken down into section candidates based on the syntactical document structure (sentence breaks, paragraph breaks, bullet lists, indentation level, etc.). The section candidates may be classified using a transformer-based architecture deep learning model. A base of such a model may be trained on a baseline set of electronic documents and a set of domain-specific electronic documents, and then additionally trained (e.g., retrained, tuned, etc.) on user input data from a specific document type. This type of model may be less generic and specific to the domain-specific electronic documents and may predict root-level labels (e.g., sections) for the electronic document. Once a candidate example has a classification prediction, processor 106 may evaluate a confidence value of the model's prediction and may compare various statistics (token/character length, position in document, etc. with metadata linked to observations of examples of that section type during training). Finally, an original token window may be adjusted around the section candidate and may predict a label concurrently for many alternative start and end boundaries. In some embodiments, processor 106 may compare the predicted labels and confidence values to identify boundaries for a given section and to increase confidence in the prediction.

In some embodiments, for identifying sentence and segment-level classification, processor 106 may read the tree-based data structure in memory 108 for a node that corresponds to a given portion of text character data. If processor 106 does not find any child nodes, processor 106 terminates the analysis. If processor 106 does find at least one child node for a section, processor 106 then tokenizes that section into at least sentences (e.g., for sentence-level segments), clauses/phrases (e.g., for phrase-level segments), words (e.g., for word-level segments), and/or characters (e.g., for character and/or token-level segments). Processor 106 may store and/or retrieve statistical data on each known sub-label for a section in terms of a mean and a variance of length, a typical grammatical structure, etc. when identifying a candidate portion of text character data. Processor 106 and machine learning model 116 (e.g., via ML model execution module) then may predict a label for each portion of text character data. For predictions passing a predetermined confidence value threshold, processor 106 may examine variations on the token window for that segment (described above) to increase the confidence value and more accurately detect boundaries. Processor 106 may also read and/or retrieve flow control logic in the corresponding node in terms of whether a certain child node is optional or required by a parent node, if there are multiple options allowed versus mutually exclusive options, etc. For this approach, processor 106 may use a blend of machine learning models 116, including classical machine learning models, deep learning (transformer) models, as well as heuristics-based approaches on parts of speech and lexical/semantic similarity. In some embodiments, mapping and/or identification of tokens may be similar to identification of sentences and phrases described above, in a recursive fashion.

### Vectorization

Once each segment (e.g., token, portion of text character data, and/or the like) of Doc1 is stored in a node of the tree-based data structure in memory 108, processor 106 may vectorize Doc1 (e.g., generate a single dimensional array of data for Doc1). The lowest layer of nodes to which text character data is mapped may contain the actual text character data of the document in a distributed arrangement throughout the “leaves” of the tree-based data structure. In this way, data vectorization system 102 may store the text character data in memory 108 in relation to only the lowest layer of nodes, rather than storing the text character data in every node, thus reducing storage requirements for electronic document data while increasing the context of the data because relationships of the text character data are represented in memory 108 by the tree-based data structure. Thus, processor 106 may detect which nodes “fire” and which nodes do not “fire” for a given electronic document (e.g., Doc1) and processor 106 may generate a vector representing the electronic document (e.g., a series of binary zeros and ones that may be stored in memory 108 that express a unique signature of an electronic document's content). Vectorization by processor 106 may depend on a “vectorspace” (e.g., a non-redundant aggregation of every possible permutation of vectors for a given electronic document type). In some embodiments, the vectorspace may be determined by every electronic document of an electronic document type that is input into machine learning model 116 (e.g., a retraining and/or tuning process described herein). Once all of these electronic documents have been stored in the tree-based data structure in memory 108, processor 106 may read and/or retrieve the vectorspace in that processor 106 may be able to access every possible permutation of segments (e.g., portions of text character data) of a document type that have input into data vectorization system 102 and stored in memory 108 as text data vectors. For example, for an electronic document type of a legal contract, data vectorization system 102 may receive text datasets for electronic documents that have been signed and/or agreed upon by parties to the contract. Once data vectorization system 102 maps and vectorizes the text character data in all of the text datasets, data vectorization system 102 may access a vectorspace for the legal contract electronic document type and may retrieve and/or detect every possible permutation of text data vectors of the legal contract that had been signed and agreed to.

In some embodiments, one assumption may be that a vectorspace for a given electronic document type includes a closed universe of electronic document, or reflects a complete set of all permutations possible for a given electronic document type. While this assumption may not hold for some electronic document types (e.g. novels) it may hold much for other electronic document types (e.g. legal documents), which may be composed largely of text of precedential documents and rarely introduce novel language in newly generated electronic documents. Thus, when a need for novel language in a legal document arises (for example, when occurrence of a worldwide pandemic results in the need to disclaim certain pandemic-related risks in a legal document), processor 106 may generate a new branch/leaf/node in the tree-based data structure in memory 108 to account for this addition to a vectorspace of a given electronic document type.

In some embodiments, as plural machine learning models are deployed and monitored for a certain electronic document type, confidence of a classification of new document instances (inference) may be monitored as well as user input data relating to accuracy may be monitored. When machine learning model 116 incorrectly classifies text character data, then the incorrectly classified text character data may represent a node of the tree-based data structure that insufficiently captures a semantic variation. Processor 106 may cause at least one display device to render a user interface (“UI”) such that processor 106 may automatically record document areas and facilitate splitting an existing node in order to capture variation and increase accuracy in classification of an electronic document type. It should be appreciated that for a majority of electronic documents of a specific electronic document type, this may not be necessary.

Referring to the example of Doc1 described herein (given a certain vectorspace), a Doc1 vector element A (document-level node), X (section-level node), a (sentence-level node), 3 (phrase-level node), ii (token-level node) is “5 years”. Electronic documents that have been previously input into data vectorization system 102 may include text character data representing options such as “2 years”, “3 years”, and/or “4 years” in a token-level node AXa3ii. Thus, after Doc1 has been mapped and analyzed by data vectorization system 102, a complete vectorspace for the node AXa3ii may include “2 years”, “3 years”, “4 years”, and “5 years”. Thus, a null vectorspace for AXa3ii may be “0000” (because there are four options, each option may be assigned to one bit in memory 108) and the element of Doc 1 vector represented in AXa3ii is “0001” (because the fourth option, “5 years” is firing in the vector for Doc1).

### Display Vector Frequency

In the example described referring to Doc1, instead of four options in the vectorspace, there may be a larger number of electronic documents input to and analyzed by data vectorization system 102. For this example, it may be assumed that 172 electronic documents (e.g., 172 text datasets) have been input, analyzed, and vectorized by data vectorization system 102 for storage in memory 108. The 172 electronic documents may have generated the following distribution for the population of vector AXa3ii: “2 years” (27x) “3 years” (32x) “4 years” (64x) “5 years” (49x). Thus, upon data vectorization system 102 receiving Doc1, processor 106 may cause at least one display device to display a frequency value of vector AXa3ii (“5 years”) for Doc1 compared to the entire vectorspace stored in memory 108 for the electronic document type matching the electronic document type of Doc1. For example, processor 106 may determine that about 29% of electronic documents in the vectorspace of D1 include text character data representing a time period of “5 years”.

### Display of Vector Through Coloration

Referring to the same example of Doc1 with the frequency value, processor 106 may cause the at least one display device to display frequency data through a visual change (e.g., in color) to text character data of Doc1 displayed as raw text on the at least one display device. For example, processor 106 may cause the at least one display device to display a spectrum (e.g., via coloration) representing 0% to 100%, with a visual spectrum of colors superimposed thereon. Thus, in this example, red may cohere with 0% and violet may cohere with 100% and orange, yellow, green, blue, and indigo may represent frequency values between 0% and 100%. Processor 106 may cause the at least one display device to display AXaxii of Doc1 as “5 years” since at ˜29% frequency in the vectorspace, the coloration may fall somewhere between yellow and green on the visible spectrum of colors superimposed on the raw text displayed by the at least one display device. The visible spectrum display of raw text for text character data may allow a user the ability to read and/or interpret multiple electronic documents simultaneously through visualization of how Doc1 compares to the vectorspace. It should be appreciated that the basis of the visual spectrum (e.g., coloring, positioning, graphs, and/or the like) may be represented in various formats. In addition, it should be appreciated that a color scheme for the visual spectrum coloration may vary, and could be simpler using less colors, more colors, or a different order of colors described herein.

### Vector Scoring

Referring to the same example of Doc1 with the frequency value, detection by processor 106 (e.g., “firing”) of the text data vector AXa3ii may have a positive, negative, or neutral impact on an analysis of Doc1. Such an impact may be quantified and added (subtracted) or multiplied (divided) into a total quantification of interests (e.g., a “score”, interest score value, and/or the like) under the electronic document in various permutations of these operations, all designed to capture the impact of the firing or non-firing of a single node on the entire electronic document's meaning from the perspective of interests.

For example, each option for AXa3ii may act as a multiplier on the rest of the interest score value of Doc1. In one example, the phrase “ . . . shall not knowingly disclose” may have a negative impact on a score as it is a restriction, though to a lesser degree than a phrase “ . . . shall not disclose” as this latter formulation represents a semantically broader restriction (since the inclusion of the “knowingly” qualifier implies permission of other kinds of disclosures). Processor 106 may determine interest score values and processor 106 may cause the at least one display device to display the interest score values in a table or visible spectrum, the same as or similar to how frequencies are displayed. Interest score values may be compared to an average interest score value for the vectorspace for any nodal layer.

### Change Tracking

Change tracking may be improved after importing electronic document types of type “contract” or other documents into data vectorization system 102 because an entire electronic document may be represented as a nested, hierarchical structure in the tree-based data structure in memory 108. For each node, an interest score value as well as a qualitative description may be displayed. These scores may also be displayed hierarchically. Additionally, external changes to an electronic document may be tracked as a revised electronic document may be re-imported into data vectorization system 102 and analyzed for changes, again both qualitatively via explanations that are attached to nodes, as well as hierarchical differences in scores in updated sections.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling system 700 to perform the functions disclosed herein. It will be apparent to persons having skill in the relevant art that such processes result in system 700 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A computing system for automatic analysis of text character data using artificial intelligence, the computing system comprising:
memory configured with storage locations storing text character data;
a first storage device configured for storing machine learning models and text character data of a text dataset;
at least one display device; and
a processor configured with program code that, when executed, will cause the processor to:
receive a text dataset including text character data;
load and execute a machine learning model stored on the first storage device, wherein the text dataset is provided as input to the machine learning model;
generate an inference for the text character data based on analyzing one or more features of the text character data;
map the text character data to a tree-based data structure in memory locations of the memory based on one or more dimensions of the text character data, wherein the tree-based data structure includes a recursive network including a root node and plural child nodes associated with the root node, wherein the tree-based data structure contains a lower layer of child nodes associated with the root node, and wherein the text character data is mapped to the lower layer of child nodes in the memory;
generate plural text data vectors for the text character data based on at least one of the plural child nodes and the root node associated with the text character data, wherein each of the plural text data vectors corresponds to a memory location in the memory;
generate at least one display output based on the plural text data vectors for the text character data; and
display the display output on the at least one display device.

2. The computing system of claim 1, wherein each child node in the memory is associated with a label based on the child node and each parent node that is associated with the child node.

3. The computing system of claim 1, wherein, when mapping the text character data to the tree-based data structure in memory locations of the memory based on the one or more dimensions of the text character data, the program code will cause the processor to map the text character data to one or more higher-level child nodes associated with the lower-level child nodes and the root node.

4. The computing system of claim 1, wherein the program code, when executed, will cause the processor to:
determine a frequency value, rarity value, or conditional rule-based value of the plural text data vectors for the text character data in the memory; and
display the frequency value, rarity value, or conditional rule-based value of the plural text data vectors for the text character data as the display output on the at least one display device.

5. The computing system of claim 4, wherein the display output includes the text character data displayed as text characters including a coloration of the text characters corresponding to the frequency value, wherein the coloration of the text characters is based on a frequency value range of 0% to 100%.

6. The computing system of claim 4, wherein the program code, when executed, will cause the processor to:
determine a score for the text dataset based on the plural text data vectors, wherein the score is determined using a semantic polarity of the plural text data vectors for the text character data in the memory; and
display the score for the text dataset as a table on the at least one display device.

7. The computing system of claim 6, wherein the program code, when executed, will cause the processor to:
receive plural text datasets, each text dataset including text character data;
store, in the memory, plural scores of the plural text datasets, each text dataset resulting in the plural data vectors for the text character data in the memory;
determine an average score for plural text datasets received by the processor based on the plural scores stored in the memory; and
display the average score with the score for a single text dataset on the at least one display device.

8. A computer-implemented method for determining semantic differences in electronic documents using artificial intelligence, the method comprising:
storing, with at least one processor, a first set of text data vectors in memory corresponding to a first electronic document file;
receiving, with at least one processor, a text dataset in the form of a second electronic document file, the electronic document file including text character data;
mapping, with at least one processor, the text character data to a tree-based data structure in memory locations of the memory based on the one or more dimensions of the text character data that allows for naïve clustering of similar documents and can represent all possible semantic variation within a corpus of documents;
generating, with at least one processor, a second set of text data vectors for the text character data based on the mapping of the text character data to the tree-based data structure in the memory;
comparing, with at least one processor, the second set of text data vectors for the text character data to the first set of text data vectors corresponding to the first electronic document file, wherein differences between the second set of text data vectors and the first set of text data vectors are stored as delta text data vectors; and
detecting, with at least one processor, at least one semantic difference between the first electronic document file and the second electronic document file based on the delta text data vectors.

9. The computer-implemented method of claim 8, further comprising:
generating, with the at least one processor, a display output based on the delta text data vectors, the second text data vectors, and the first text data vectors; and
displaying, with a display device, the display output.

10. The computer implemented method of claim 8, wherein the tree-based data structure includes a recursive network of root nodes and plural child nodes associated with the root nodes, wherein a first portion of the plural child nodes are lower-level child nodes and a second portion of the plural child nodes are higher-level child nodes, and wherein the text character data is mapped to the lower-level child nodes in the memory.

11. The computer-implemented method of claim 8, further comprising:
executing a trained machine learning model;
inputting the text character data to the trained machine learning model; and
generating, with the trained machine learning model, one or more classifications including encoding a constituent and/or syntactic structure of electronic documents for the text character data based on analyzing one or more features of the text character data in the electronic document file.

12. The computer-implemented method of claim 11, wherein the one or more classifications include any one of a document classification, a section classification, a sentence classification, a phrase classification, and a token classification.

13. The computer implemented method of claim 11, further comprising:
executing plural trained machine learning models;
inputting the text character data to the plural trained machine learning models; and
generating, with the plural trained machine learning models, plural classifications for the text character data based on analyzing one or more features of the text character data in the second electronic document file;
wherein the plural classifications include any one of a document classification, a section classification, a sentence classification, a phrase classification, and a token classification.

14. The computer-implemented method of claim 8, further comprising:
determining a frequency value of text data vectors of the second set of text data vectors for the text character data in the memory; and
displaying the frequency value of the text data vectors of the second set of text data vectors as a display output on the at least one display device.

15. The computer-implemented method of claim 14, wherein the display output includes the text character data displayed as text characters including a color corresponding to the frequency value, wherein the color is based on a frequency value range of 0% to 100%.

16. The computer-implemented method of claim 14, further comprising:
determining a score for the second electronic document file based on the second set of text data vectors, wherein the score is determined using the frequency value of the text data vectors of the second set of text data vectors; and
displaying the score for the text dataset in a table format on the at least one display device.

17. The computer-implemented method of claim 16, further comprising:
receiving plural electronic document files, each electronic document file including text character data;
storing, in the memory, plural scores of the plural electronic document files, each electronic document file resulting in plural data vectors for the text character data in the memory;
determining an average score for the plural electronic document files based on the plural scores stored in the memory; and
displaying the average score with the score for the second electronic document file on the display device.

18. A computer program product for analyzing electronic documents, the computer program product including a non-transitory computer-readable medium including program code that, when executed by a processor, causes the processor to:
receive text character data;
input the text character data to a machine learning model;
classify the text character data based on a classification output of the text character data generated by the machine learning model;
map the text character data to a tree-based data structure in memory locations of the memory based on one or more dimensions of the text character data that allows for naïve clustering of similar documents and can represent all possible semantic variation within a corpus of documents;
generate plural text data vectors for the text character, wherein the plural text data vectors represent the mapping of the text character data to the tree-based data structure;
generate a display output based on the plural text data vectors for the text character data; and
display the display output on the at least one display device.

19. The computer program product of claim 18, wherein the tree-based data structure includes a recursive network of root nodes and plural child nodes associated with the root nodes, wherein a first portion of the plural child nodes are lower-level child nodes and a second portion of the plural child nodes are higher-level child nodes, and wherein the text character data is mapped to the lower-level child nodes in the memory.

20. The computer program product of claim 18, wherein the program code, when executed by the processor, causes the processor to:
determine a frequency value, rarity value, or conditional rule-based value of the plural text data vectors for the text character data in the memory, wherein the memory can be managed; and
display the frequency value, rarity value, or conditional rule-based value of the plural text data vectors for the text character data as the display output on at least one display device.
